(19) United States
(12) Patent Application Publication
(10) Pub. No.: US 2025/0042004 A1
(43) Pub. Date: Feb. 6, 2025

(54) ROTARY IMPACT TOOL

(71) Applicant: MILWAUKEE ELECTRIC TOOL CORPORATION, Brookfield, WI (US)

(72) Inventors: Mackenzie J. Nick, Theresa, WI (US); Jacob P. Schneider, Cedarburg, WI (US); Andrew D. Bendtsen, Oak Creek, WI (US); Nathan P. Sievers, West Allis, WI (US)

(21) Appl. No.: 18/716,092

(22) PCT Filed: Dec. 1, 2022
(86) PCT No.: PCT/US2022/051519

§ 371 Date: Jun. 3, 2024

Related U.S. Application Data
(60) Provisional application No. 63/284,887, filed on Dec. 1, 2021.

(51) Int. Cl. B25B 21/02; B25B 23/147

(52) U.S. Cl. CPC B25B 21/02; B25B 23/1475

(57) ABSTRACT

A power tool includes a housing, a motor mounted within the housing and including a stator with an outer diameter and a rotor having a shaft configured to rotate about an axis relative to the stator. The power tool also includes a gear assembly operably coupled to the motor and including a ring gear fixed relative to the housing and planet gears meshed with the ring gear. A drive assembly is operably coupled to the gear assembly to receive torque from the shaft through the gear assembly. The power tool also includes a rear bearing rotatably supporting a rearward portion of the shaft and a forward bearing rotatably supporting a forward portion of the shaft. A distance measured between a front edge of the rear bearing and a rear edge of the forward bearing is less than the outer diameter of the stator.

### CROSS-REFERENCE TO RELATED APPLICATIONS

This application claims priority to U.S. Provisional Patent Application No. 63/284,887 filed on Dec. 1, 2021, the entire contents of which are incorporated by reference herein.

### FIELD

The present invention relates to power tools, and more particularly to rotary impact tools, such as impact wrenches.

### BACKGROUND

Rotary impact tools are typically utilized to provide a striking rotational force, or intermittent applications of torque, to a tool element or workpiece (e.g., a fastener) to either tighten or loosen the fastener.

### SUMMARY

The present invention provides, in one aspect, a power tool including a housing, a motor mounted within the housing, the motor including a stator defining an outer diameter and having a plurality of windings, and a rotor having a shaft configured to rotate about an axis relative to the stator. The power tool also includes a gear assembly operably coupled to the motor, the gear assembly including a ring gear fixed relative to the housing and a plurality of planet gears meshed with the ring gear. A drive assembly is operably coupled to the gear assembly to receive torque from the shaft through the gear assembly and includes a camshaft, an anvil, and a hammer configured to reciprocate along the camshaft to impart rotational impacts to the anvil in response to rotation of the camshaft. The power tool also includes a rear bearing rotatably supporting a rearward portion of the shaft and a forward bearing rotatably supporting a forward portion of the shaft. A distance measured between a front edge of the rear bearing and a rear edge of the forward bearing is less than the outer diameter of the stator.

Optionally, the housing includes a first portion and a second portion coupled together at a seam, and an end cap coupled to the first and second portions.

Optionally, the first portion and the second portion define a motor housing portion directly supporting the stator.

Optionally, the power tool includes an impact case coupled to the housing, and the impact case surrounds the drive assembly.

Optionally, the power tool includes an intermediate housing disposed between the motor housing portion and the impact case, and the ring gear, the impact case, and the intermediate housing at least partially define a sealed chamber containing the gear assembly and the drive assembly.

Optionally, the rear bearing is supported by the end cap.

Optionally, the ring gear includes a boss extending rearwardly along the axis, and the forward bearing is received within and supported by the boss.

Optionally, the ring gear includes a toothed portion and a flange portion extending from the toothed portion, and the flange portion rotatably supports the camshaft.

Optionally, the outer diameter of the stator is 50 mm to 70 mm.

Optionally, the power tool includes a battery removably coupled to the housing and configured to provide power to the motor.

The present invention provides, in another aspect, a power tool including a housing having a first housing portion and a second housing portion coupled to the first housing portion, the first and second housing portions contacting one another at a seam, a motor directly mounted within the housing between the first and second housing portions, a gear case integrally formed by the first and second housing portions, a gear assembly supported within the gear case and operably coupled to the motor, and a drive assembly operably coupled to the gear assembly. The drive assembly includes a camshaft, an anvil, and a hammer configured to reciprocate along the camshaft to impart rotational impacts to the anvil in response to rotation of the camshaft. The power tool further includes an impact case coupled to the housing. The impact case surrounds the hammer and the anvil. The impact case has a first end facing the housing and a second end opposite the first end, and the anvil extends through the second end of the impact case. The impact case and the gear case define a chamber containing a lubricant, and the power tool includes a sealing system positioned at least partially between the gear case and the impact case to inhibit lubricant from escaping out of the chamber.

Optionally, the first and second housing portions define a slot, and the ring gear is supported within the slot.

Optionally, the housing includes a dividing wall extending between the motor and the gear assembly, the shaft of the motor extends through an opening in the dividing wall, and the ring gear is seated against the dividing wall.

Optionally, the ring gear includes a boss extending rearwardly along the axis, and the shaft of the motor is supported by a bearing received within the boss.

Optionally, the housing and the impact case are coupled together by one or more fasteners each received in an insert fixed within the housing and formed of a metal material.

The present invention provides, in another aspect, a power tool including a housing having a first housing portion and a second housing portion each made of a polymer material, the first and second housing portions coupled together at a seam, a motor mounted within the housing between the first and second housing portions, the motor including a shaft configured to rotate about an axis, a gear case containing lubricant and being integrally formed by the first and second housing portions, and a gear assembly supported within the gear case and operably coupled to the motor. The gear assembly includes a ring gear engaged with the gear case and a plurality of planet gears meshed with the ring gear. The power tool also includes a drive assembly operably coupled to the gear assembly. The drive assembly includes a camshaft, an anvil, and a hammer configured to reciprocate along the camshaft to impart rotational impacts to the anvil in response to rotation of the camshaft. An impact case made of a metal material is coupled to the housing and surrounds the drive assembly. The impact case contains a lubricant. The power tool further includes a seal inhibiting the lubricant from migrating out of the gear case and the impact case.

Optionally, the sealing system further includes at least a first portion, a second portion, and a third portion, and the first, second, and third portions seal the chamber.

Optionally, the first portion of the sealing system is at least partially positioned between the first and second housing portions on upper and lower parts of the chamber.

Optionally, the gear assembly further incudes a plurality of planet gears, and a ring gear surrounding the plurality of planet gears, and the first portion surrounds the ring gear.

Optionally, a groove is formed between the first and second housing portions, and the first portion of the sealing system is received in the groove.

Optionally, a portion of the groove includes an L-shape, and the first portion is received around the ring gear and in the groove.

Optionally, the first portion of the sealing system includes two mirroring portions positioned opposite one another.

Optionally, the second portion of the sealing system is positioned adjacent the first end of the impact case and the third portion of the sealing system is positioned adjacent the second end of the impact case, the second portion of the sealing system is retained between the impact case the housing, and the third portion of the sealing system is retained by a seal retainer surrounding the anvil.

Optionally, the housing includes a front end portion and the impact case includes a rim received within and overlapped by the front end portion, and the second portion of the sealing system includes an O-ring sandwiched between the front end portion of the housing and the rim.

Optionally, the first, second, and third portions of the sealing system are formed as separate pieces, the first portion positioned between the gear assembly and the housing to seal a rear end of the chamber, the second portion positioned between the impact case and the housing to seal an intermediate portion of the chamber, the third portion of the sealing system is positioned between the drive assembly and the impact case to seal a front of the chamber, and the first portion of the sealing system extends between the rear end of the chamber to the intermediate portion of the chamber.

The present invention provides, in another aspect, a power tool including a housing including a first housing portion and a second housing portion each made of a polymer material, the first and second housing portions coupled together at a seam, a motor mounted within the housing between the first and second housing portions, the motor including a shaft configured to rotate about an axis, a gear case containing lubricant and being integrally formed by the first and second housing portions, a gear assembly supported within the gear case and operably coupled to the motor, the gear assembly including a ring gear engaged with the gear case, and a plurality of planet gears meshed with the ring gear, and a drive assembly operably coupled to the gear assembly. The drive assembly includes a camshaft, an anvil, and a hammer configured to reciprocate along the camshaft to impart rotational impacts to the anvil in response to rotation of the camshaft. The power tool also includes an impact case made of a metal material and coupled to the housing, the impact case surrounding the drive assembly and containing a lubricant, and a seal inhibiting lubricant from migrating out of the gear case and the impact case.

Optionally, the first and second housing portions define a slot, and wherein the ring gear is supported within the slot.

Optionally, the housing includes a dividing wall extending between the motor and the gear assembly, wherein the shaft of the motor extends through an opening in the dividing wall, and wherein the ring gear is seated against the dividing wall.

Optionally, the ring gear includes a boss extending rearwardly along the axis, and wherein the shaft of the motor is supported by a bearing received within the boss.

Optionally, the housing and the impact case are coupled together by one or more fasteners each received in an insert fixed within the housing and formed of a metal material.

The present invention provides, in another aspect, a power tool including a housing with first and second housing portions coupled together at a seam: a motor mounted within the housing and including an output shaft rotatable about an axis: an impact case coupled to the housing: an impact mechanism supported at least partially within the impact case, the impact mechanism including a camshaft, an anvil, and a hammer configured to reciprocate along the camshaft to impart rotational impacts to the anvil in response to rotation of the camshaft, and a gear assembly supported within the housing and operably coupled to the output shaft. The gear assembly includes a plurality of planet gears surrounding a portion of the output shaft and a ring gear surrounding the plurality of planet gears. The power tool also includes a bushing supported by the housing between the camshaft and the gear assembly. The plurality of planet gears is coupled to the camshaft by one or more pins such that the plurality of planet gears is cantilevered off of the camshaft.

Optionally, each of the first and second housing portions form a first groove configured to directly receive the gear assembly and a second groove configured to directly receive the bushing, wherein the first and second grooves are offset relative one another along the axis.

Optionally, the first groove receives the ring gear, and the ring gear includes one or more lugs that contact the housing to inhibit rotational movement of the ring gear relative the housing.

Optionally, the second groove receives the bushing, and the bushing includes one or more lugs that contact the housing to inhibit rotational movement of the bushing relative the housing.

Optionally, the bushing includes at least four lugs.

Optionally, the bushing at least partially supports the camshaft in the housing, and the one or more pins pass through an aperture of the bushing between the planet gears and the camshaft.

The present invention provides, in another aspect, a power tool including a housing having a motor housing portion and a handle housing portion extending from the motor housing portion. The housing is made of a molded polymer material. The power tool further includes a motor supported within the motor housing portion, a trigger supported by the handle housing portion, the trigger configured to operate the motor, a battery receptacle configured to receive a battery pack that can be removably coupled to the power tool, the battery receptacle including one or more support rails molded therein, a PCBA positioned within the handle housing portion and in electrical communication with the motor assembly, the trigger, and the battery receptacle, and a frame molded within the handle housing portion and at least partially surrounding the PCBA, the frame configured to reinforce the handle housing. The frame is made of a different material than the housing.

Optionally, the power tool includes a grip overmolded on the handle housing portion, the grip configured to be grasped by a user during operation of the power tool.

Optionally, the frame includes a plurality of frame members molded within the handle housing portion.

Optionally, the plurality of frame members extends between the battery receptacle and the trigger.

Optionally, the plurality of frame members extends from the battery receptacle and beyond the trigger.

Optionally, each of the frame members is made of metal.

Optionally, each of the frame members includes a plurality of apertures.

Optionally, one of the plurality of frame members includes a slot that accommodates an electronic component mounted to the PCBA.

Optionally, the frame is a first frame, the power tool further comprises a second frame molded within the battery receptacle, and the second frame is made of a different material than the housing.

Optionally, the second frame is made of metal.

Optionally, the second frame strengthens the rails of the battery receptacle.

Optionally, the first frame and the second frame include metal stampings.

Optionally, the battery receptacle includes an elastomeric element engageable with the battery pack when the battery pack is coupled to the power tool.

Optionally, the elastomeric element is one of a plurality of elastomeric elements located in the battery receptacle and engageable with the battery pack.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

FIG. 1 is a perspective view of a power tool according to an embodiment of the invention.

FIG. 2A is a cross-sectional view of the power tool of FIG. 1 taken along line 2A-2A in FIG. 1, shown with a battery pack of the power tool removed and illustrating a callout around a portion of a sealing system of the power tool.

FIG. 2B is a magnified view of a portion of an alternate sealing system usable with the power tool when positioned in an area of the callout illustrated in FIG. 2A.

FIG. 2C is a cross-sectional view of a portion of the power tool of FIG. 1.

FIG. 3 is quarter-sectional view of the power tool of FIG. 1.

FIG. 4 is a perspective view of a handle portion of the power tool of FIG. 1 with a first housing portion hidden.

FIG. 5 is a cross-sectional view of the handle portion of the power tool of FIG. 1, taken along line 5-5 in FIG. 1.

FIG. 6 is a partially exploded bottom perspective view of the handle portion of FIG. 4.

FIG. 7 is a cross-sectional view taken along line 7-7 in FIG. 4, with the battery pack removed.

FIG. 8 is a partially exploded view of the power tool of FIG. 1.

FIG. 9 is a side view of the power tool of FIG. 1, with a first housing portion hidden to reveal motor, gear, and drive assemblies.

FIG. 10 is a side perspective view of the power tool of FIG. 1, with the first housing portion and a portion of the gear assembly hidden.

FIG. 11 is a cross-sectional view of the power tool of FIG. 1, taken along line 11-11 in FIG. 1.

FIG. 12 is an isolated view of the sealing system of FIG. 2.

FIG. 13 is a perspective view of a sealing system according to another embodiment, useable with the power tool of FIG. 1.

FIG. 14 is an enlarged view of a seal connection of the sealing system of FIG. 13.

FIGS. 15 and 16 are dimensioned views of the power tool of FIG. 1, illustrating certain dimensions associated with the power tool in some embodiments.

FIG. 17A is a cross-sectional view of a power tool according to another embodiment of the invention.

FIG. 17B is a magnified view of a portion of a sealing system in an area of the callout illustrated in FIG. 17A.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

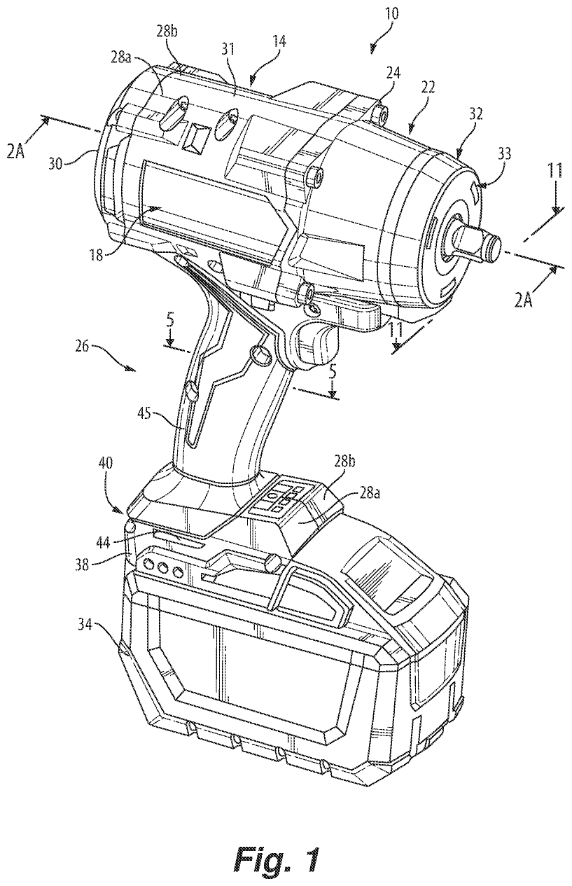

FIG. 1 illustrates an embodiment of a power tool in the form of a rotary impact tool, and, more specifically, an impact wrench 10. The impact wrench 10 includes a housing 14 with a motor housing portion 18, an impact case or front housing portion 22 coupled to the motor housing portion 18 (e.g., by a plurality of fasteners 24), and a handle portion 26 extending downwardly from the motor housing portion 18. In the illustrated embodiment, the handle portion 26 and the motor housing portion 18 are defined by cooperating first and second clamshell halves or housing portions 28a, 28b.

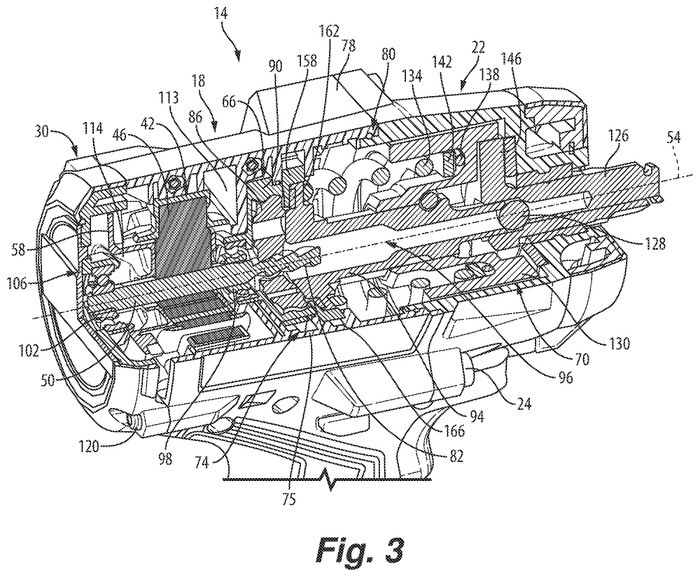

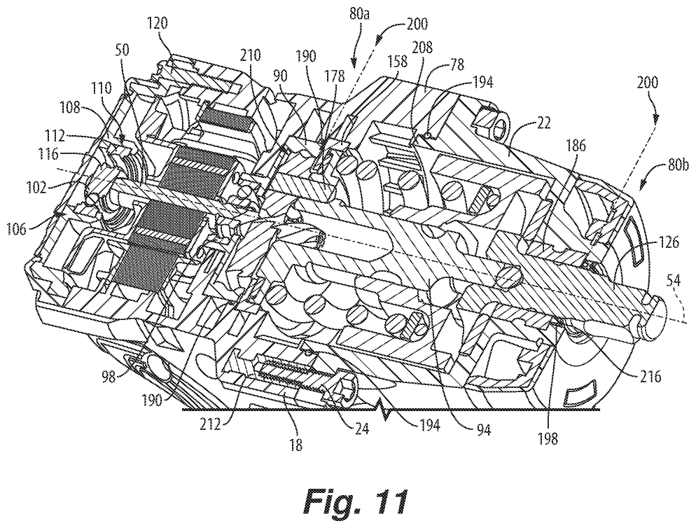

The illustrated housing 14 also includes an end cap 30 coupled to the motor housing portion 18 opposite the front housing portion 22. The clamshell halves 28a, 28b can be coupled (e.g., fastened) together at an interface or seam 31. In the illustrated embodiment, the end cap 30 is continuous and may be pressed or fitted over a rear end of the clamshell halves 28a, 28b. In other words, the end cap 30 may not include two halves such that the end cap 30 may extend over the seam 31. The end cap 30 is coupled to the motor housing portion 18 by a plurality of fasteners 120 (FIGS. 3 and 11). In other embodiments, the end cap 30 may be integrally formed with the motor housing portion 18.

The impact wrench 10 further includes a lighting assembly 32 with one or more lighting sources 33. The illustrated lighting assembly 32 surrounds the front housing portion 22 and may serve as a cap at a front end of the front housing portion 22. In some embodiments, the lighting assembly 32 may include one or more lenses covering the one or more lighting sources 33. In some embodiments, the one or more lighting sources 33 may be light-emitting diodes (LEDs) arranged about a center point of the lighting assembly 32.

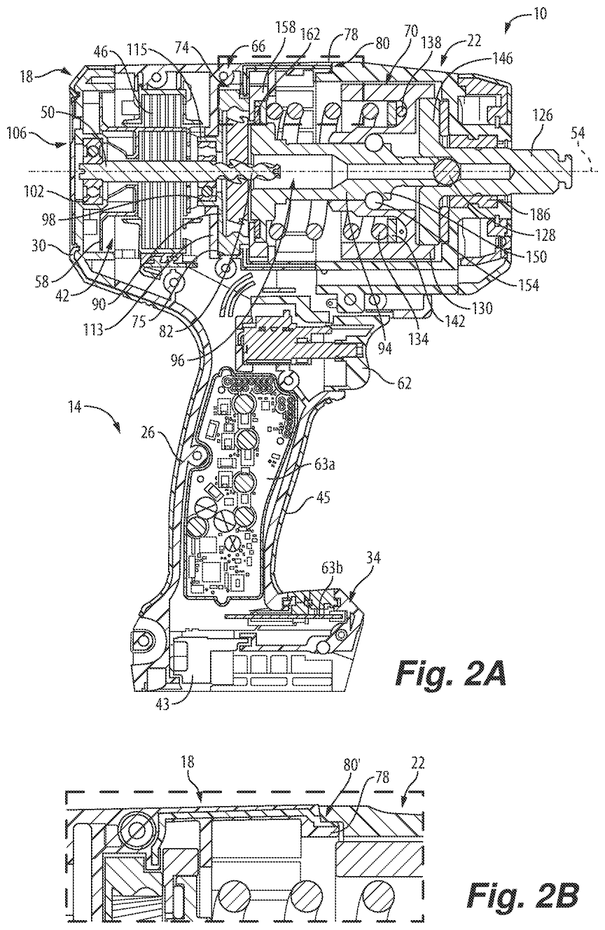

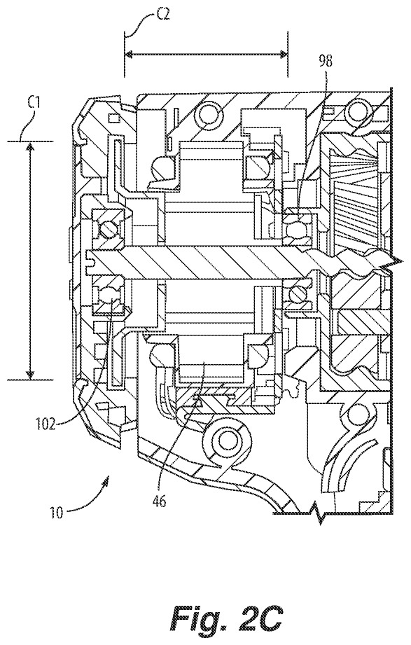

Referring to FIG. 1, the impact wrench 10 includes a battery 34 removably coupled to a battery receptacle 38 located at a bottom end or foot 40 of the handle portion 26. A motor 42 (FIG. 2A) is supported within the motor housing portion 18 and receives power from the battery 34 via connections, pads, and/or battery terminals 43 supported by the battery receptacle 38 when the battery 34 is coupled to the battery receptacle 38. The foot 40 may include, as illustrated in FIG. 1, one or more vents 44 (e.g., air vents, cooling vents, etc.). In the illustrated embodiment, the handle portion 26 of the clamshell halves 28a, 28b can be covered or surrounded by a grip portion 45.

The battery 34 may be a power tool battery pack generally used to power a power tool, such as an electric drill, an electric saw; and the like (e.g., an 18 volt rechargeable battery pack, or an M18 REDLITHIUM battery pack sold by Milwaukee Electric Tool Corporation). The battery 34 may include lithium ion (Li-ion) cells. In alternate embodiments, the battery packs may be of a different chemistry (e.g., nickel-cadmium (NiCa or NiCad), nickel-hydride, and the like). In the illustrated embodiments, the battery 34 is an 18 volt battery pack. In alternate embodiments, the capacity of the battery 34 may vary (e.g., the battery may be a 4 volt battery pack, a 28 volt battery pack, a 40 volt battery pack, or a battery pack of any other voltage suitable for powering the impact wrench 10.

With reference to FIGS. 2A and 3, in the illustrated embodiment, the motor 42 is a brushless direct current (“BLDC”) motor with a stator 46 and a rotor with an output shaft 50 that is rotatable about an axis 54 relative to the stator 46. In other embodiments, other types of motors may be used. A fan 58 is coupled to the output shaft 50 behind the motor 42 to generate airflow: In the illustrated embodiment, the motor 42 is operable (e.g., controlled) without the use of Hall-Effect sensors. As such, no printed circuit board is needed adjacent the front or back end of the motor 42, allowing for a shorter length required in the housing 14 to accommodate the motor 42.

The impact wrench 10 also includes a switch 62 (e.g., a trigger switch: FIG. 2) supported by the housing 14 that selectively electrically connects the motor 42 (e.g., via suitable control circuitry provided on one or more printed circuit board assemblies (“PCBAs”) 63a, 63b, and the battery 34, to provide DC power to the motor 42. In other embodiments, the impact wrench 10 may include a power cord for electrically connecting the switch 62 and the motor 42 to a source of AC power. As a further alternative, the impact wrench 10 may be configured to operate using a different power source (e.g., a pneumatic or hydraulic power source, etc.).

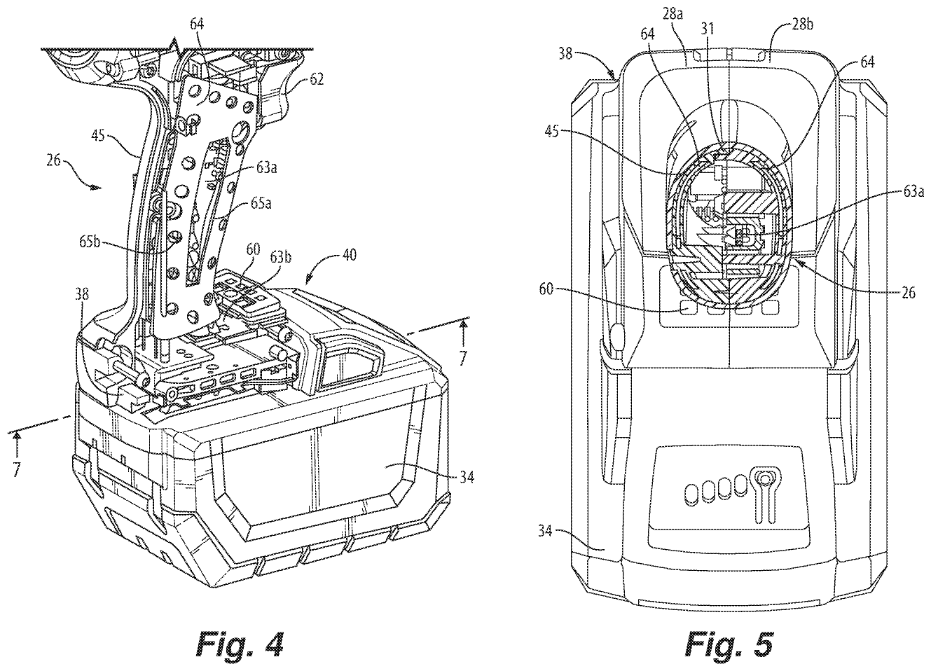

Referring now to FIG. 4, the first PCBA 63a is positioned within the handle portion 26 and is in electrical communication with the motor 42, the switch 62, and the battery receptacle 38. In the illustrated embodiment, the first PCBA 63a includes a plurality of semi-conductor switching elements (e.g., MOSFETs, IGBTs, or the like) that control and distribute power to windings in the stator 46 in order to cause rotation of the rotor and output shaft 50. The first PCBA 63a may also include one or more microprocessors, machine-readable, non-transitory memory elements, and other electrical or electronic elements for providing operational control to the impact wrench 10.

With continued reference to FIG. 4, the illustrated impact wrench 10 includes a second PCBA 63b situated in the foot 40 of the impact wrench 10. The second PCBA 63b includes one or more indicators 60 configured to indicate an operating status or mode of the impact wrench 10. The second PCBA 63b may also include one or more communication modules (e.g., BLUETOOTH, Wi-Fi, or the like) for linking with an external device to control the operating status or mode of the impact wrench 10.

With reference to FIGS. 4 and 5, a frame 64 (e.g., one or more stampings, shields, plates, and/or the like) is embedded within the handle portion 26 and at least partially surrounds the first PCBA 63a. In the illustrated embodiment, the frame 64 includes multiple frame members situated within the handle portion 26 adjacent the grip portion 45. For example, each of the clamshell halves 28a, 28b may include an embedded frame member to collectively define the frame 64. The frame members are formed as stamped plates in the illustrated embodiment, with curved regions generally matching the curvature of the grip portion 45.

The frame 64 reinforces the handle portion 26 against, for example, flexing, cracking, bending, and/or the like. The frame 64 is made of a different material than the handle portion 26 and is preferably made of a high strength material, such as metal, a metal composite, or another reinforcing material such as carbon fiber, fiber-reinforced polymer, or the like. The illustrated frame 64 is embedded (e.g., molded) within the handle portion 26 and therefore allows the walls of the handle portion 26 to be made thinner while maintaining sufficient strength, thereby decreasing the weight of the impact wrench 10 and providing more volume within the handle portion 26 to accommodate the first PCBA 63a. In the illustrated embodiment, the frame 64 extends from the battery receptacle 38 toward and at least partially past the switch 62.

In the illustrated embodiment, the frame 64 includes a central, slot-shaped recess 65a extending in a length direction of the handle portion 26. The recess 65a provides additional clearance to accommodate electronics on the first PCBA 63a, such as one or more capacitors. The frame 64 also includes a plurality of circular recesses 65b arranged about a periphery of the frame 64. The recesses 65b may provide flow channels for the polymer material of the handle portion 26 during molding of the handle portion 26, further securing the frame 64 within the handle portion 26.

In the illustrated embodiment, as best shown in FIG. 5, the clamshell halves 28a, 28b are positioned to at least partially overlap one another at the seam 31, and the grip portion 45 is shaped to surround the mated clamshell halves 28a, 28b. Fasteners (e.g., fasteners 24) may be threaded, pinned, inserted, etc. into each of the clamshell halves 28a, 28b to further secure the housing 14 of the handle portion 26 in a closed or generally sealed position. In some embodiments, the fasteners 24 in the handle portion 26 may also extend through the frame 64.

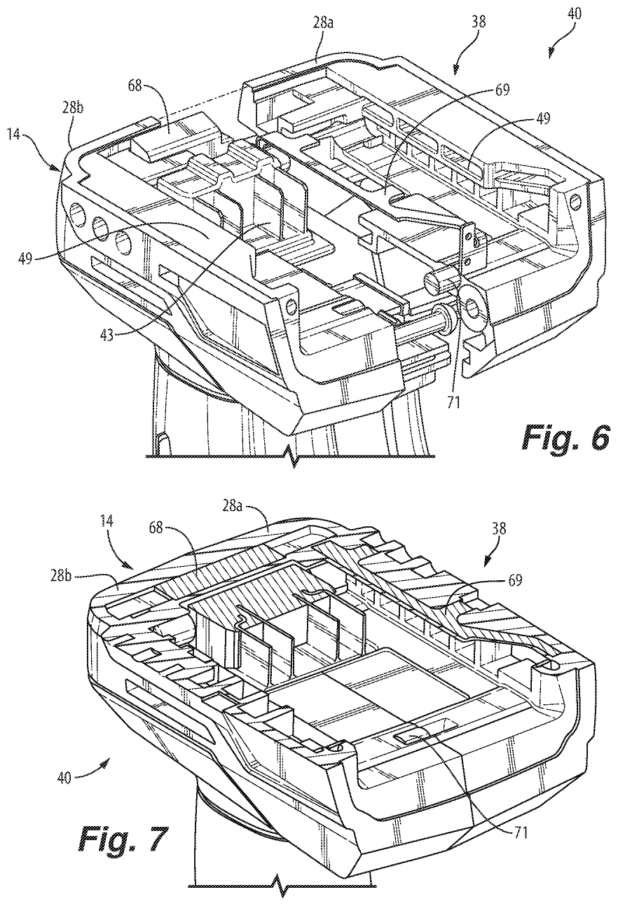

Referring now to FIGS. 6 and 7, the battery receptacle 38, which is adjacent the foot 40 and includes the battery terminals 43, further includes a ramp or detent 68 that is configured to engage with the battery 34 when the battery 34 is coupled to the battery receptacle 38. In some embodiments, the detent 68 is made of a resilient, elastomeric material, such as rubber. In other embodiments, the detent 68 may be biased into engagement with the battery 34 by a spring. In the illustrated embodiment, one or more slugs 71, such as elastomeric or rubber stoppers, may be inserted into portions of the foot 40 proximate a front end of the battery receptacle 38. The detent 68 and the slugs 71 take up tolerance space between the battery 34 and the receptacle 38 to provide a snug fit between the battery 34 and the receptacle 38.

In the illustrated embodiment, the battery receptacle 38 further includes a frame 69 supported within (e.g., positioned, inserted, molded, formed in, etc.) the battery receptacle 38. The illustrated frame 69 is made of one or more metal stampings (or any other suitable high-strength material) and provides additional strength and durability for guide rails 49 that slidably interface with and support the battery 34. Like the frame 64, the frame 69 may be embedded (e.g., molded) within the respective clamshell halves 28a, 28b.

Referring now to FIGS. 2A-3, the impact wrench 10 further includes a gear assembly 66 driven by the output shaft 50 and an impact mechanism 70 coupled to an output of the gear assembly 66. The impact mechanism 70 may also be referred to herein as a drive assembly 70. The gear assembly 66 may be configured in any of a number of different ways to provide a speed reduction between the output shaft 50 and an input of the drive assembly 70. The gear assembly 66 is at least partially housed within a gear case or gear housing 74 that is formed by the housing 14. Specifically, the clamshell halves 28a, 28b form a groove 75 that directly receives the gear assembly 66 and at least partially forms the gear housing 74. As will be described in greater detail below, the gear assembly 66 and gear housing 74 of the impact wrench 10 further reduces an overall length of the impact wrench 10.

In the illustrated embodiment, with specific reference to FIGS. 2A-3, a front end portion 78 of the motor housing portion 18 receives and overlaps a part of the front housing portion 22. In the illustrated embodiment, the gear housing 74 and front housing portion 22 may contain lubricant, such as grease or oil, the assists in smooth operation of the impact wrench 10. As will be discussed in greater detail below, the impact wrench 10 further includes a sealing system 80 positioned at least partially between the gear case 74 and the front housing portion 22 to inhibit lubricant from escaping out of the front housing portion 22.

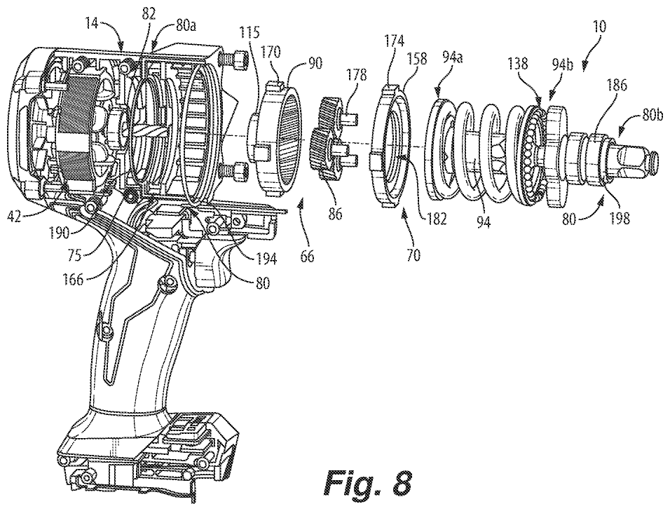

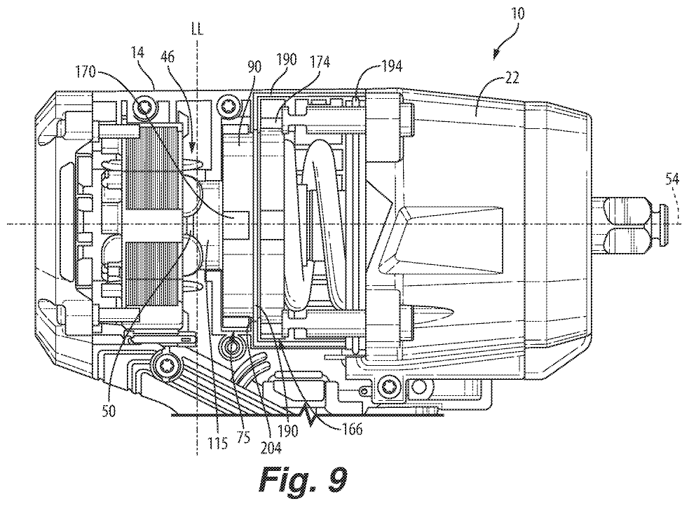

As illustrated in FIG. 3, the gear assembly 66 includes a helical pinion 82 formed on the output shaft 50 of the motor 42, a plurality of helical planet gears 86 meshed with the helical pinion 82, and a helical ring gear 90 meshed with the planet gears 86 and rotationally fixed within the housing 14 (e.g., gear housing 74). More specifically, the illustrated ring gear 90 includes a plurality of lugs 170 (FIGS. 8 and 9). In the illustrated embodiment, the lugs 170 of the ring gear 90 fit within the groove 75 formed by the clamshell halves 28a, 28b to support and constrain the ring gear 90 in a rotational direction. A rearward facing side of the ring gear 90 is seated against a dividing wall 113 formed by the clamshell halves 28a, 28b. The dividing wall 113 separates the gear housing 74 from the motor 42.

With continued reference to FIG. 3, the planet gears 86 are coupled to a camshaft 94 of the drive assembly 70 such that the camshaft 94 acts as a planet carrier. Accordingly, rotation of the output shaft 50 rotates the planet gears 86, which then advance along the inner circumference of the ring gear 90 and thereby rotate the camshaft 94. In the illustrated embodiment, the camshaft 94 includes a through-hole 96 extending through the camshaft 94 along the axis 54 (FIG. 3). The through-hole 96 is shaped to accommodate and/or receive at least a portion of the helical pinion 82. In the illustrated embodiment, the through-hole 96 extends through the entire length of the camshaft 94, which reduces the weight of the camshaft 94; however, the through-hole 96 may extend only partially through the camshaft 94 in other embodiments.

Referring to FIGS. 2A and 3, the output shaft 50 is rotatably supported by a first or forward bearing 98 and a second or rear bearing 102. The output shaft 50 extends through an opening in the dividing wall 113. The helical-type gears/pinions 82, 86, 90 of the gear assembly 66 may advantageously provide higher torque capacity and quieter operation than spur gears, for example, but the helical engagement between the helical pinion 82 and the planet gears 86 produces an axial thrust load on the output shaft 50. Accordingly, the impact wrench 10 includes a hub or bearing retainer 106, integrally formed by the end cap 30, which secures the rear bearing 102 both axially (e.g., against forces transmitted along the axis 54) and radially (i.e. against forces transmitted in a radial direction of the output shaft 50).

With reference to FIG. 3, the fan 58 includes a frusto-conical recess 114 and the bearing retainer 106 extends into the frusto-conical recess 114 such that at least a portion of the bearing retainer 106 and at least a portion of the rear bearing 102 overlap the fan 58 along the axis 54. This overlapping arrangement advantageously reduces the axial length of the impact wrench 10.

Referring now to FIGS. 2A and 9, the forward bearing 98 supports the output shaft 50 and, because the motor 42 does not require a sensor board on its front face, the forward bearing 98 is able to be axially recessed in the stator 46. In the illustrated embodiment, the ring gear 90 includes a boss extending rearwardly through the opening in the dividing wall 113 and forming a bearing support 115 that receives and supports the forward bearing 98. In other words, the forward bearing 98 is coupled to and supported by the ring gear 90 (e.g., at an outer race of the forward bearing 98), such that a portion of the ring gear 90 extends between the housing 14 and the forward bearing 98 in a radial direction of the bearing 98. In this manner, the housing 14, ring gear 90, forward bearing 98 and output shaft 50 each overlap along the axis 54. In other words, at least one line LL can be drawn in a radially outward direction from the output shaft 50 that intersects the forward bearing 98, the stator 46, and the bearing support 115 of the ring gear 90 (FIG. 9). This overlapping arrangement advantageously reduces the axial length of the impact wrench 10 and is again facilitated by the lack of a sensor board at the front side of the motor 42.

As illustrated in FIG. 2C, the stator 46 has an outer diameter C1, and the forward bearing 98 and the rear bearing 102 are separated by a distance C2. More specifically, the distance C2 is measured between a front end of the rear bearing 102 and a rear end of the forward bearing 98. In the illustrated embodiment, the distance C2 between the bearings 98, 102 is less than the diameter C1 of the stator 46. In some embodiments, the diameter C1 of the stator 46 may be 50 mm to 70 mm, 50 mm to 60 mm, 55 mm to 60 mm, or 50 mm to 55 mm. The motor 42 thus has a relatively large diameter to length ratio, such that the motor 42 may be able to supply a relatively large amount of power in a relatively compact overall length.

The drive assembly 70 of the impact wrench 10 will now be described with reference to FIGS. 2A and 3. The drive assembly 70 includes an anvil 126, extending from the front housing portion 22, to which a tool element (not shown) can be coupled for performing work on a workpiece (e.g., a fastener). The drive assembly 70 is configured to convert the constant rotational force or torque provided by the gear assembly 66 to a striking rotational force or intermittent applications of torque to the anvil 126 when the reaction torque on the anvil 126 (e.g., due to engagement between the tool element and a fastener being worked upon) exceeds a certain threshold. In the illustrated embodiment of the impact wrench 10, the drive assembly 70 includes the camshaft 94, a hammer 130 supported on and axially slidable relative to the camshaft 94, and the anvil 126. Stated another way, the hammer 130 is configured to reciprocate axially along the camshaft 94 to impart rotational impacts to the anvil 126 in response to rotation of the camshaft 94.

The through-hole 96 of the camshaft 94 extends into the anvil 126 (e.g., into a bore, inner recess, and/or the like) and opens up to an anvil ball 128 positioned within the anvil 126. The camshaft 94 contacts the anvil ball 128 such that the anvil ball 128 provides a wear contact between the camshaft 94 and the anvil 126 to prevent over-wear to the anvil. In some embodiments, the anvil ball 128 has a diameter of approximately 5.00-15.00 mm. In the illustrated embodiment, the anvil ball 128 has a diameter of approximately 10.00 mm.

With continued reference to FIGS. 2A and 3, the drive assembly 70 further includes a spring 134 biasing the hammer 130 toward the front of the impact wrench 10 (e.g., in the right direction of FIG. 2A). In other words, the spring 134 biases the hammer 130 in an axial direction toward the anvil 126, along the axis 54. A thrust bearing 138 (see also FIG. 8) and a thrust washer 142 are positioned between the spring 134 and the hammer 130. The thrust bearing 138 and the thrust washer 142 allow for the spring 134 and the camshaft 94 to continue to rotate relative to the hammer 130 after each impact strike when lugs (not shown) on the hammer 130 engage with corresponding anvil lugs 146 and rotation of the hammer 130 momentarily stops.

The camshaft 94 further includes cam grooves 150 in which corresponding cam balls 154 are received. The cam balls 154 are in driving engagement with the hammer 130 and movement of the cam balls 154 within the cam grooves 150 allows for relative axial movement of the hammer 130 along the camshaft 94 when the hammer lugs and the anvil lugs 146 are engaged and the camshaft 94 continues to rotate.

In the illustrated embodiment, with continued reference to FIGS. 2A and 3, the impact wrench 10 further includes a bushing 158 supported by the housing 14 between the camshaft 94 and the gear assembly 66. The bushing 158 receives a washer or wear ring 162 positioned in a relief space or annular groove formed by a rear end portion of the camshaft 94. Like the gear assembly 66 being supported in the groove 75 formed by the clamshell halves 28a, 28b, the bushing 158 is supported in a groove 166 formed by the clamshell halves 28a, 28b. In other words, each of the first and second housing portions 28a, 28b form a first groove (e.g., groove 75) configured to directly receive the gear assembly 66 and a second groove (e.g., groove 166) configured to directly receive the bushing 158. The bushing 158 is thus positioned in and constrained by the housing 14 to absorb a rearward force generated by the spring 134 against the camshaft 94. In some embodiments, the bushing 158 may abut a front surface of the ring gear 90.

While typical impact-type power tools include a camshaft bearing to rotationally support a camshaft within a gear case, the cantilevered planet gears 86 radially support and the bushing 158 axially supports the rear end of the camshaft 94 in the illustrated embodiment, which results in an overall length reduction of the impact wrench 10 relative such typical power tools. Specifically, such bearings of typical impact-type power tools include balls contained between inner and outer races such that the bearing must be at least as long or wide as the diameter of the balls. These bearings also require support from bearing retainers, which even further increases a depth or length of the bearing assembly and thus the tool. Obviating such camshaft bearings may also increase a torque-to-length ratio and reduce an overall weight of the impact wrench 10 relative typical impact-type power tools.

Referring now to FIGS. 8-10, and the bushing 158 includes a plurality of lugs 174. The lugs 174 of the bushing 158 fit within grooves 166 of the housing 14 and provide a rigid base for the axial load or force exerted by the spring 134. In the illustrated embodiment, the bushing 158 includes four lugs 174 positioned equally about a circumference of the bushing 158 to support the bushing 158 in the housing 14.

As further illustrated in FIG. 8, the plurality of planet gears 86 are coupled to a first end 94a of the camshaft 94 by one or more pins 178 (see also FIG. 11), which extend through an aperture 182 of the bushing 158. In other words, the pins 178 pass through the aperture 182 of the bushing 158 from the planet gears 86 to the camshaft 94 without contacting the bushing 158. A second end 94b of the camshaft 94 is supported by the anvil 126, which is retained in the front housing portion 22 by an anvil bushing 186 (see also FIG. 2A)

Referring now to FIGS. 8-14, the sealing systems 80, 80′ will be described in greater detail. As illustrated in FIG. 8, the sealing system 80, which may also be referred to as a seal assembly 80, includes a rear seal portion 190, an intermediate seal portion 194, and a forward of front seal portion 198. In some embodiments, each seal portion 190, 194, 198 is made of a flexible/semi-flexible polymer material, such as rubber, neoprene, silicone, or the like. In general, the seal assembly 80 defines a sealed chamber 200 (FIGS. 11 and 12) that contains lubricant between a first end 80a and a second end 80b of the sealing system 80. As also shown in FIGS. 11 and 12, the chamber 200 is at least partially defined by the housing 14 (e.g., motor housing 18) and the front housing portion 22.

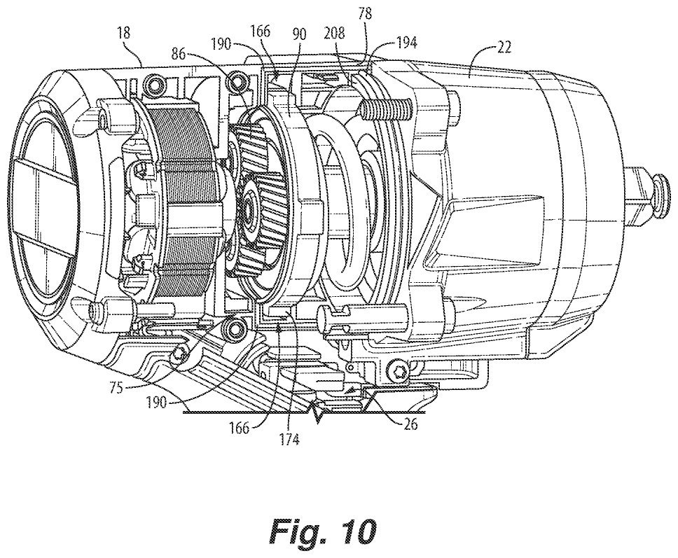

With specific reference to FIGS. 9 and 10, the first end 80a of the sealing system 80 is generally adjacent the bushing 158 and ring gear 90 (e.g., the first end 94a of the camshaft 94), and the second end 80b is positioned adjacent the anvil 126 and the anvil bushing 186. In the illustrated embodiment, the rear seal portion 190 at least partially surrounds the ring gear 90 and extends into a slot or groove 204 formed in each of the clamshell halves 28a, 28b. For example, the groove 204 may be formed partially in the first clamshell half 28a and partially in the second clamshell half 28b such that the seam 31 at which the clamshell halves 28a, 28b contact one another is sealed shut by at least the rear seal portion 190.

In the illustrated embodiment, at least a part of the rear seal portion 190, and thus the groove 204, forms an L-shape when extending through the housing 14. The rear seal portion 190 may be compressed, stretched, and/or otherwise retained around the gear assembly 66 to inhibit lubricant from migrating out of the gear housing 74 (e.g., out of the housing 14, into the motor housing 18, into the handle portion 26, etc.). An upper extension of the rear seal portion 190 may inhibit lubricant from escaping out of the impact wrench 10 though the clamshell halves 28a, 28b (e.g., through the seam 31), and a lower extension of the rear seal portion 190 may inhibit lubricant from migrating into the handle portion 26 (e.g., through the seam 31). In some embodiments, the rear seal portion 190 may be fed or pressed into the groove 204 during assembly of the impact wrench 10.

In the illustrated embodiment, the L-shaped part of the rear seal portion 190 extends around the groove 166 of the gear assembly 66 (e.g., around and/or to surround the ring gear 90) to further seal the gear assembly 66. As illustrated in FIG. 12, the rear seal portion 190 is formed of two separate parts 190a, 190b that each extend around a portion of the ring gear 90 and in the L-shaped groove 204. Forming the rear seal portion 190 as the two separative parts 190a, 190b eases in the manufacturing (e.g., assembling, forming, etc.) of the impact wrench 10 such that the rear seal portion 190 can be coupled (e.g., connected, inserted, etc.) to the impact wrench 10 from opposing sides or ends of the impact wrench 10. In other words, the two separative parts 190a, 190b of the rear seal portion 190 are generally mirrored relative one another across the axis 54. In the illustrated embodiment, the rear seal portion 190 includes multiple 90-degree deviations, one deviation between the ring gear 90 and the motor housing 18, and another deviation within the groove 204 (e.g., in the L-shaped portion of the groove 204).

As shown best in FIG. 10, the rear seal portion 190 and groove 204 may extend into the front end portion 78 and into the front housing portion 22. The rear seal portion 190 may further contact (e.g., press against, abut, etc.) the intermediate seal portion 194. In the illustrated embodiment, the intermediate seal portion 194 is a flexible (e.g., compressible, stretchable, etc.) O-ring 194. The O-ring 194 may be stretched around a rim 208 of the front housing portion 22. In the illustrated embodiment, as illustrated in FIG. 10, the rim 208 is situated to be overlapped by the front end portion 78 of the housing 14, and the O-ring 194 is compressed and/or positioned between the rim 208 and the front end portion 78 to seal the housing 14 and the front housing portion 22 together. In other words, the rim 208 and the front end portion 78 may circumferentially overlap each other such that the O-ring 194 may contribute to a circumferential seal between the motor housing 18/gear housing 74 and the front housing portion 22.

As emphasized in FIGS. 10 and 11, the planet gears 86 can fit within a recess 210 of the ring gear (hidden in FIG. 10) such that lubricant is generally allowed to reach the planet gears 86, pinion 82, ring gear 90, and pins 178 within the gear assembly 66 but not rearwardly beyond the ring gear 90. In the illustrated embodiment, the O-ring 194 is positioned between the front housing portion 22 and the motor housing 18 to seal an intermediate portion of the chamber 200 that is generally between the first and second ends 80a, 80b of the sealing system 80.

With reference to FIGS. 9-11, each of the fasteners 24 may be threaded into an insert 212 formed in the motor housing 18. In the illustrated embodiment, the insert 212 and fastener 24 are formed of metal, such as steel, stainless steel, aluminum, and/or the like. In some embodiments, the fasteners 24 are M6 machine screws with hexagonal head caps that may be threaded into the insert 212. When fastened (e.g., threaded) together, the fasteners 24 pull the motor housing 18 and the front housing portion 22 together to squeeze or bear against the O-ring 194. Therefore, the motor housing 18 and the front housing portion 22 can be coupled together around a portion of the sealing system 80 to inhibit lubricant from escaping out of the housing 14 between, for example, the motor housing 18 and the front housing portion 22.

In the illustrated embodiment, the motor housing 18 and handle portion 26 include a rigid polymer or plastic material and the front housing portion 22 is metal. The sealing system 80 therefore seals together two housings (e.g., motor housing 18 and front housing portion 22) that are formed of different materials. In the illustrated embodiment, the motor housing 18 and the gear housing 74 are made of a first polymer material and the front housing portion 22 is made of metal. In some embodiments, portions of the motor housing 18 that support the gear assembly 66 (e.g., the gear housing 74) may include additional and/or differently composed material (e.g., stronger) to support the gear assembly 66.

With specific reference to FIGS. 11 and 12, the front seal portion 198 is retained between the anvil bushing 186 and a seal retainer 216. For example, the front housing portion 22 may include a plug, insert, ridge, or the like that functions as the seal retainer 216 to prevent the front seal portion 198 from moving in the front housing portion 22. In the illustrated embodiment, the sealed chamber 200 is defined between the ring gear 90 (e.g., at the rear end 80a) and the seal retainer 216 (e.g., at the front end 80b). In other words, the rear seal portion 190 inhibits lubricant from migrating axially rearwardly of the gear assembly 66 and radially out of the housing 14, and the front seal portion 198 inhibits lubricant from migrating axially forwardly of the front seal portion 198 and/or seal retainer 216. The front seal portion 198 may further reduce wobble or shifting of the anvil 126 to reduce seizure or damage of the anvil 126. As best illustrated in FIG. 12, the front seal portion 198, the O-ring 194, and the rear seal 190 may be discontinuous, disconnected, separate pieces, and/or the like.

In the illustrated embodiment, the seal assembly 80 is inserted into the housing 14 (e.g., rear seal portion 190 and/or intermediate seal portion 194) and/or front housing portion 22 (e.g., front seal portion 198) after the clamshell halves 28a, 28b are formed. For example, the clamshell halves 28a, 28b may be molded (e.g., blow molded, injection molded, etc.) with the groove 204 formed therein and then the rear seal portion 190 may be secured in the groove 204. Similarly, the front housing portion 22 may be formed (e.g., machined, stamped, etc.) and then the front seal portion 198 may be inserted into the front housing portion 22 between the front housing portion 22 and the anvil 126. In some embodiments, at least a portion of the seal assembly 80 may be integrally formed (e.g., co-molded) with the clamshell halves 28a, 28b.

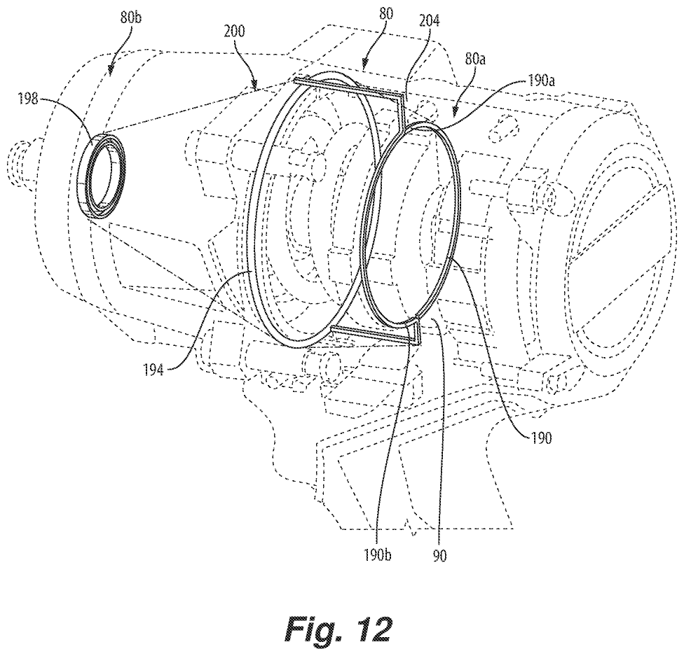

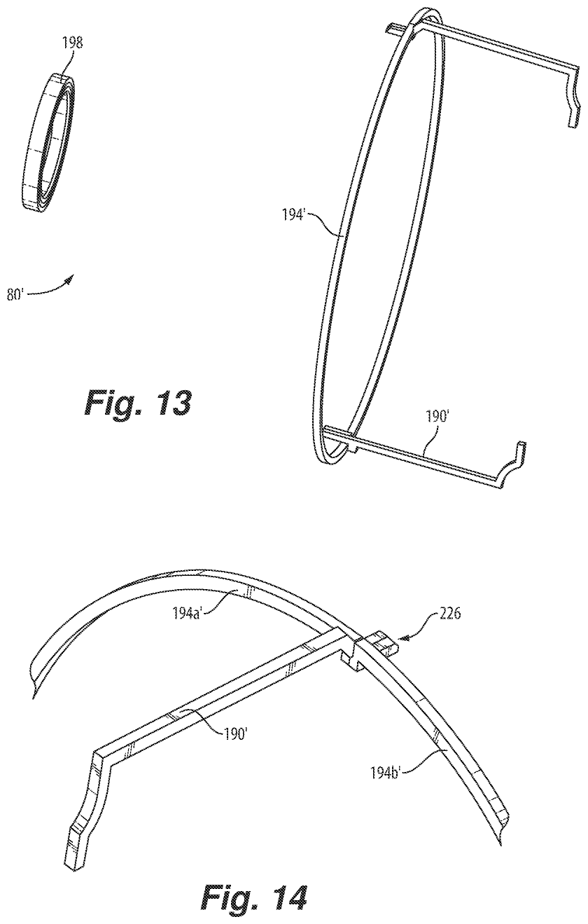

With reference to FIGS. 13 and 14, the alternate seal assembly or sealing system 80′ includes alternate rear seal portions 190′ and intermediate seal portions 194′ that are usable with the impact wrench 10 in substantially the same way as the seal assembly 80. For example, the rear seal portion 190′ can be inserted/compressed/sandwiched in the slot or groove 204 formed in the motor housing 18. Although not particularly illustrated, the rear seal portion 190′ also includes, like the rear seal portion 190, a portion that extends around or against the ring gear 90.

As specifically illustrated in FIG. 14, the rear seal portion 190′ may be coupled to first and second intermediate seal portions 198a′, 198b′ generally shaped to fit between the rim 208 of the front housing portion 22 and the front end portion 78 of the motor housing 18 (FIG. 10). In the illustrated embodiment, the rear seal portion 190′ and the first and second intermediate seal portions 198a′, 198b′ are not continuous with one another such that all three meet at together at a common coupling 226. In other embodiments, the rear seal portion 190′ and the first and second intermediate seal portions 198a′, 198b′ can be coupled together either before or after assembly with the impact wrench 10. In one application of the alternate seal assembly 80′, the common coupling 226 may serve to seal at least a part of the seam 31 of the clamshell halves 28a, 28b as well as at least a part of the connection between the front housing portion 22 and the motor housing 18.

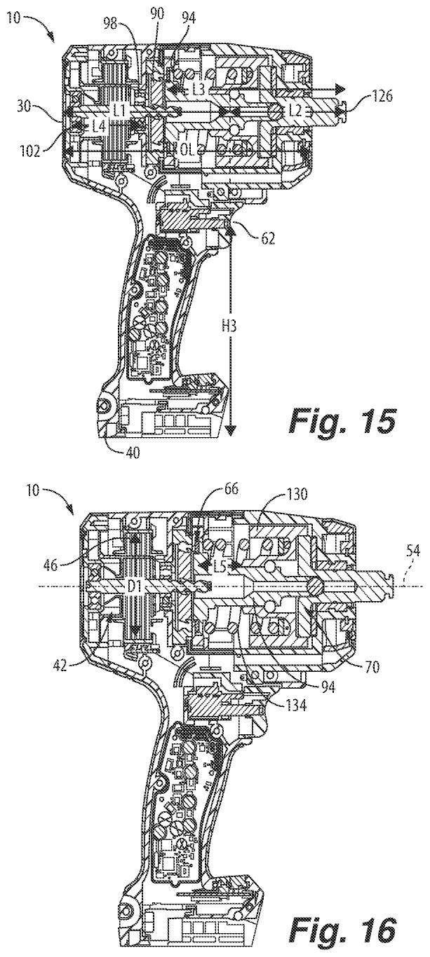

Referring now to FIGS. 15 and 16, dimensions of the impact wrench 10, according to one example construction, include a first length L1 defined axially between an end of the end cap 30 and an end of the switch 62. In the illustrated embodiment, the first length L1 may be between approximately 100.00 mm and approximately 120.00 mm (e.g., 109.32 mm).

The impact wrench 10 may include a second length L2 defined axially between the end of the switch 62 and a tip of the anvil 126. In the illustrated embodiment, the second length L2 may be between approximately 60.00 mm and approximately 80.00 mm (e.g., 69.40 mm).

The impact wrench 10 may further include a third length L3 defined axially between the tip of the anvil 126 and a first end of the ring gear 90/camshaft 94. In the illustrated embodiment, the third length L3 may be between approximately 110.00 mm and approximately 130.00 mm (e.g., 119.823 mm).

The impact wrench 10 may further include a fourth length L4 defined axially between a rear end of the rear bearing 102 and a rear end of forward bearing 98. In the illustrated embodiment, the fourth length L4 may be between approximately 40.00 mm and approximately 60.00 mm (e.g., 49.60 mm).

The impact wrench 10 may also include a height H3 defined linearly between the end of the switch 62 (e.g., generally in the center of the switch 62) and a bottom of the foot 40. In the illustrated embodiment, the height may be between approximately 110.00 mm and approximately 140.00 mm (e.g., 127.19 mm).

As illustrated in FIG. 16, the impact wrench 10 may also include a fifth length L5 defined axially between a rear end of the camshaft 94 and a rear end of the hammer 130 when the spring 134 is in an uncompressed or free state/condition. In the illustrated embodiment, the fifth length L5 may be between approximately 10.00 mm and approximately 40.00 mm (e.g., 29.1295 mm).

As also illustrated in FIG. 16, the stator 46 of the impact wrench 10 may have a dimension D1 defined linearly between ends of the stator 46 (e.g., when taken across the axis 54). In the illustrated embodiment, the dimension D1 may be between approximately 40.00 mm and approximately 80.00 mm (e.g., 60.00 mm).

The impact wrench 10 may thus have an overall size ratio of approximately greater than 2.0, where size ratio can be defined by the following expression:

$$Size Ratio 3 = \frac{D 1}{L 5} > 2.$$

This expressed overall size ratio may provide accurate/preferred drive, gear, and motor assemblies (e.g., drive assembly 70, gear assembly 66, motor 42/motor assembly). The motor 42 and hammer 130 of the impact wrench 10 are compact in the housing 14 and positioned closer to the handle portion 26 than typical impact-type power tools. For example, the combined dimensions (e.g., L1, L2, L3, L4, L5, H3, and D1) of the illustrated impact wrench 10 are not known in the art such that the impact wrench 10 has advanced ergonomics without sacrificing operation capabilities (e.g., torque transmission, form factor, and/or the like).

In some embodiments, as illustrated in FIGS. 15 and 16, an overall length OL of the impact wrench 10 may be between approximately 175.00 mm and approximately 205.00 mm (e.g., 187.96 mm), and an overall height OH of the impact wrench 10 may be between approximately 225.00 mm and approximately 255.00 mm (e.g., 234.95 mm). In the illustrated embodiment, the overall height OH is 1.25 times greater than the overall length OL

The features and dimensions of the impact wrench 10, as described above, allow the impact wrench 10 to be both compact and lightweight. The illustrated impact wrench has a total weight, not including the battery 34, between 5.0 and 5.4 pounds in some embodiments, or between 5.0 and 5.2 pounds in some embodiments. Furthermore, the impact wrench 10 is capable of delivering at least 1,000 ft-lbs. of fastening torque to a workpiece in some embodiments, or at least 1,100 ft-lbs. of fastening torque in other embodiments. Thus, the impact wrench 10 may be capable of delivering between 185 ft-lbs. and 220 ft-lbs. of fastening torque per pound of weight.

In operation of the impact wrench 10, an operator depresses the switch 62 to activate the motor 42, which continuously drives the gear assembly 66 and the camshaft 94 via the output shaft 50. The helical engagement between the helical pinion 82 and the planet gears 86 produces a forward-directed thrust load along the axis 54 of the output shaft 50 (e.g., toward the drive assembly 70), which is transmitted to the rear bearing 102, which is secured against this thrust load by the bearing retainer 106 and/or housing 14.

As the camshaft 94 rotates, the cam balls 154 drive the hammer 130 to co-rotate with the camshaft 94, and the drive surfaces of hammer lugs to engage, respectively, the driven surfaces of anvil lugs 146 to provide an impact and to rotatably drive the anvil 126 and the tool element. After each impact, the hammer 130 moves or slides rearward along the camshaft 94, away from the anvil 126, so that the hammer lugs disengage the anvil lugs 146.

As the hammer 130 moves rearward, the cam balls 154 situated in the respective cam grooves 150 in the camshaft 94 move rearward in the cam grooves 150. The spring 134 stores some of the rearward energy of the hammer 130 to provide a return mechanism for the hammer 130. After the hammer lugs disengage the respective anvil lugs 146, the hammer 130 continues to rotate and moves or slides forwardly, toward the anvil 126, as the spring 134 releases its stored energy, until the drive surfaces of the hammer lugs re-engage the driven surfaces of the anvil lugs 146 to cause another impact.

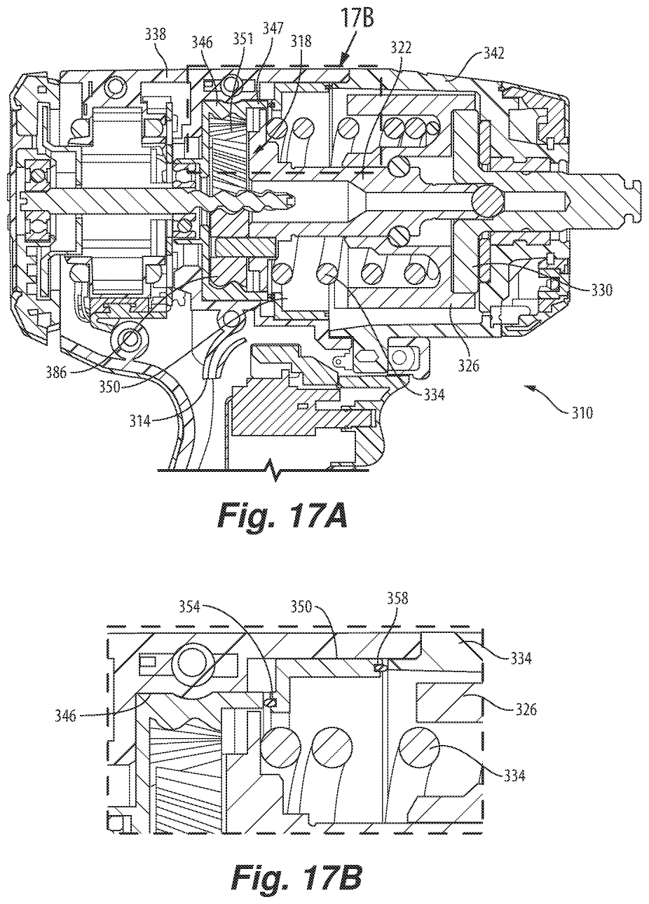

FIGS. 17A and 17B illustrate another embodiment of an impact wrench 310. The impact wrench 310 of FIGS. 17A and 17B is similar to the impact wrench 10 described above. As such, the following description focuses on differences between the impact wrench 310 and the impact wrench 10. Furthermore, features and elements of the impact wrench 10 may be incorporated into the impact wrench 310, and vice versa.

The impact wrench 310 includes a housing 314, a gear assembly 318, and a drive assembly including a camshaft 322, a hammer 326, an anvil 330, and a spring 334 that biases the hammer 326 toward the front of the impact wrench 310. The housing 314 includes a motor housing portion 338 (which may comprise first and second housing portions, like the motor housing portion 38) and an impact case or front housing portion 342 coupled to the motor housing portion 338. The gear assembly 318 includes a ring gear 346 and a plurality of planet gears 386 meshed with the ring gear 346. The hammer 326 and the anvil 330 are disposed at a front end of the impact wrench 310 within the front housing portion 342.

In the illustrated embodiment, the ring gear 346 includes a flange 347 extending forwardly from a toothed portion 351 of the ring gear 346. The planet gears 386 engage the toothed portion 351, and the rear end of the camshaft 322 is rotatably supported by the flange 347. As such, the camshaft 322 is partially nested within the ring gear 346. In some embodiments, one or more washers 353, which may be made of a low-friction material, such as Delrin® or Nylon, may be provided between the camshaft 322 and the toothed portion 351 to support the rear end of the camshaft 322 against axial forces.

The impact wrench 310 further includes an intermediate housing 350 disposed between the front housing portion 342 and the ring gear 346. More specifically, a rear end of the intermediate housing 350 is positioned adjacent the ring gear 346, and a front end of the intermediate housing 350 is positioned adjacent the front housing portion 342. In the illustrated embodiment, the intermediate housing 350 is cup-shaped and is formed of plastic. In other embodiments, the intermediate housing may have other shapes and/or may be formed of different materials.

Best illustrated in FIG. 17B, the intermediate housing 350 receives a rear seal 354 at the rear end of the intermediate housing 350 and a front seal 358 at the front end of the intermediate housing 350. When the impact wrench 310 is assembled, the rear seal 354 is compressed between the rear end of the intermediate housing 350 and the ring gear 346 to form a seal between the intermediate housing 350 and the ring gear 346, and the front seal 358 is compressed between the front end of the intermediate housing 350 and the front housing portion 342 to form a seal between the intermediate housing 350 and the front housing portion 342. Thus, the intermediate housing 350, ring gear 346, and the front housing portion or impact case 342 at least partially define a sealed chamber in which the gear assembly 318 and drive assembly are disposed. By sealing between the ring gear 346 and the front housing portion 342, the intermediate housing 350 and the seals 354, 358 may inhibit grease/lubricant within the chamber from migrating into the motor housing portion 338.

Various features of the invention are set forth in the following claims.

1-50. (canceled)

51. A power tool comprising:
a housing including a first portion and a second portion coupled together at a seam, and an end cap coupled to the first and second portions;
a motor mounted within a motor housing portion of the housing defined by the first portion and the second portion, the motor including a shaft configured to rotate about an axis;
a gear assembly operably coupled to the motor, the gear assembly including a ring gear fixed relative to the housing and a plurality of planet gears meshed with the ring gear;
a drive assembly operably coupled to the gear assembly to receive torque from the shaft through the gear assembly, the drive assembly including
a camshaft,
an anvil, and
a hammer configured to reciprocate along the camshaft to impart rotational impacts to the anvil in response to rotation of the camshaft;
an impact case coupled to the housing opposite the end cap; and
an intermediate housing disposed between the ring gear and the impact case, such that the ring gear, the impact case, and the intermediate housing at least partially define a sealed chamber containing the gear assembly and the drive assembly.

52. The power tool of claim 51, wherein the housing includes a dividing wall extending between the motor and the gear assembly, wherein the shaft extends through an opening in the dividing wall, and wherein the ring gear is seated against the dividing wall.

53. The power tool of claim 51, further comprising a lighting assembly including a cap coupled to a front end of the impact case opposite the intermediate housing and a plurality of LEDs.

54. The power tool of claim 51, wherein the ring gear includes a toothed portion and a flange portion extending from the toothed portion, and wherein the flange portion rotatably supports the camshaft.

55. The power tool of claim 51, wherein the housing and the impact case are coupled together by one or more fasteners each received in an insert fixed within the housing and formed of a metal material.

56. The power tool of claim 51, further comprising a rear bearing and a forward bearing supporting the shaft of the motor, wherein the ring gear includes a boss extending rearwardly along the axis, and wherein the forward bearing is received within and supported by the boss.

57. The power tool of claim 56, wherein the motor includes stator, and wherein a distance measured between a front edge of the rear bearing and a rear edge of the forward bearing is less than an outer diameter of the stator.

58. A power tool comprising:
a housing;
a motor mounted within the housing, the motor including a stator having a plurality of windings and a rotor having a shaft configured to rotate about an axis relative to the stator, wherein the stator defines an outer diameter;
a gear assembly operably coupled to the motor, the gear assembly including a ring gear fixed relative to the housing and a plurality of planet gears meshed with the ring gear;
a drive assembly operably coupled to the gear assembly to receive torque from the shaft through the gear assembly, the drive assembly including
a camshaft,
an anvil, and
a hammer configured to reciprocate along the camshaft to impart rotational impacts to the anvil in response to rotation of the camshaft;
a rear bearing rotatably supporting a rearward portion of the shaft; and
a forward bearing rotatably supporting a forward portion of the shaft,
wherein a distance measured between a front edge of the rear bearing and a rear edge of the forward bearing is less than the outer diameter of the stator.

59. The power tool of claim 58, wherein the housing includes a first portion and a second portion coupled together at a seam, and an end cap coupled to the first and second portions.

60. The power tool of claim 59, wherein the first portion and the second portion define a motor housing portion directly supporting the stator.

61. The power tool of claim 60, further comprising an impact case coupled to the housing, wherein the impact case surrounds the drive assembly.

62. The power tool of claim 61, further comprising an intermediate housing disposed between the motor housing portion and the impact case, wherein the ring gear, the impact case, and the intermediate housing at least partially define a sealed chamber containing the gear assembly and the drive assembly.

63. The power tool of claim 59, wherein the rear bearing is supported by the end cap.

64. The power tool of claim 59, wherein the first and second housing portions define a slot, and wherein the ring gear is supported within the slot.

65. The power tool of claim 58, wherein the ring gear includes a boss extending rearwardly along the axis, and wherein the forward bearing is received within and supported by the boss.

66. The power tool of claim 58, wherein the ring gear includes a toothed portion and a flange portion extending from the toothed portion, and wherein the flange portion rotatably supports the camshaft.

67. The power tool of claim 58, wherein the outer diameter of the stator is 50 mm to 70 mm.

68. The power tool of claim 58, wherein the housing includes a battery receptacle, and wherein the power tool further comprises a battery removably coupled to the battery receptacle and configured to provide power to the motor.

69. The power tool of claim 68, wherein the battery receptacle includes an elastomeric element engageable with the battery when the battery is coupled to the power tool.

70. A power tool comprising:
a housing including a first portion and a second portion coupled together at a seam, and an end cap coupled to the first and second portions;
a motor mounted within a motor housing portion of the housing defined by the first portion and the second portion, the motor including a shaft configured to rotate about an axis;
a gear assembly operably coupled to the motor, the gear assembly including a ring gear fixed relative to the housing and a plurality of planet gears meshed with the ring gear;
a drive assembly operably coupled to the gear assembly to receive torque from the shaft through the gear assembly, the drive assembly including
a camshaft,
an anvil, and
a hammer configured to reciprocate along the camshaft to impart rotational impacts to the anvil in response to rotation of the camshaft;
an impact case coupled to the housing opposite the end cap; and
an intermediate housing disposed between the ring gear and the impact case, such that the ring gear, the impact case, and the intermediate housing at least partially define a sealed chamber containing the gear assembly and the drive assembly.
